(19) United States
(12) Patent Application Publication
(10) Pub. No.: US 2009/0011380 A1
(43) Pub. Date: Jan. 8, 2009

(54) Dental medical tool

(76) Inventor: I Roou Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,048

(22) Filed: Jul. 2, 2007

(51) Int. Cl. A61C 3/00; A61C 17/00; A61C 5/04

(52) U.S. Cl. 433/3; 433/80; 433/89

(57) ABSTRACT

A dental medical tool comprises a coupler and a hollow grip correspondingly connected with each other, wherein the coupler contains a groove for receiving a dynamo therein, and includes an air inlet and an air outlet both communicating with the groove, and the dynamo couples with a light emitting element and includes a fan pivotally secured at the distal end thereof for utilizing the air inlet and the air outlet to generate an inclined interaction during air flowing, such that the dynamo is actuated to let a power connector output voltage for activating the light emitting element; the grip includes a treatment tool pivotally disposed thereon, and in the predetermined position thereof corresponding to the treatment tool is provided with a window, the grip further includes a light guiding element arranged thereon and extendedly coupling with the window and the light emitting element.

### BACKGROUND OF THE INVENTION

1. Field of the Invention

The present invention relates to a dental medical tool, and more particularly to a dental medical tool that may save power, provide a good heat sinking effect and further achieve an economical purpose.

2. Description of the Prior Arts

A prior art dental medical tool as disclosed in FIG. 2 of TW Publication No. 543438 comprises a grip member including a turbine head 10′ and a coupler 10″ provided thereon, the coupler 10″ includes a halogen lamp 40 provided at the inner side thereof for emitting and transmitting beam to a head portion 11 of the turbine head 10′ or a light projecting opening 41 of a neck portion 12 through a beam transmitting fiber 42, thereby the treating position may be illuminated so that the opening 41 is closely positioned thereto.

Since the halogen lamp 40 is adopted for the prior art dental medical tool and the transforming efficiency from the electric current into the beam is low, consuming power, generating heat, and further causing a poor influence on holding the dental medical tool.

Moreover, as disclosed in FIG. 1 of TW Publication No. 543438, a tool body 10 includes the turbine head 10′ having the neck portion 12 formed thereon and the coupler 10″, and includes an optical semiconductor device arranged therein for illuminating the treating position. Nevertheless, the production cost of such a prior art dental medical tool is quite expensive.

The present invention has arisen to mitigate and/or obviate the afore-described disadvantages.

### SUMMARY OF THE INVENTION

The primary object of the present invention is to provide a dental medical tool that may save power, provide a good heat sinking effect and further achieve an economical purpose.

In accordance with one aspect of the present invention, there is provided a dental medical tool comprising a coupler and a hollow grip correspondingly connected with each other, wherein the coupler contains a groove for receiving a dynamo therein, and includes an air inlet and an air outlet both communicating with the groove, and the dynamo couples with a light emitting element and includes a fan pivotally secured at the distal end thereof for utilizing the air inlet and the air outlet to generate an inclined interaction during air flowing, such that the dynamo is actuated to let a power connector output voltage for activating the light emitting element, the grip includes a treatment tool pivotally disposed thereon, and in the predetermined position thereof corresponding to the treatment tool is provided with a window, the grip further includes a light guiding element arranged thereon and extendedly coupling with the window and the light emitting element.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the assembly of a dental medical tool according to the present invention;

FIG. 2 is a plane diagram of a coupler and a grip of the dental medical tool according to the present invention;

FIG. 3 is a perspective diagram illustrating the exploded components of the dental medical tool according to the present invention;

FIG. 4 is a perspective diagram illustrating an end holder, a dynamo, a lamp mount and a light emitting element of the present invention being assembled together;

FIG. 5 is a perspective diagram of the end holder of the present invention;

FIG. 6 is a front elevational diagram of the end holder of the present invention;

FIG. 7 is a rear elevational diagram of the end holder of the present invention;

FIG. 8 is a side diagram of the dynamo of the present invention;

FIG. 9 is a rear elevational diagram of the dynamo of the present invention.

### DETAILED DESCRIPTION OF THE PREFERRED EMBODIMENT

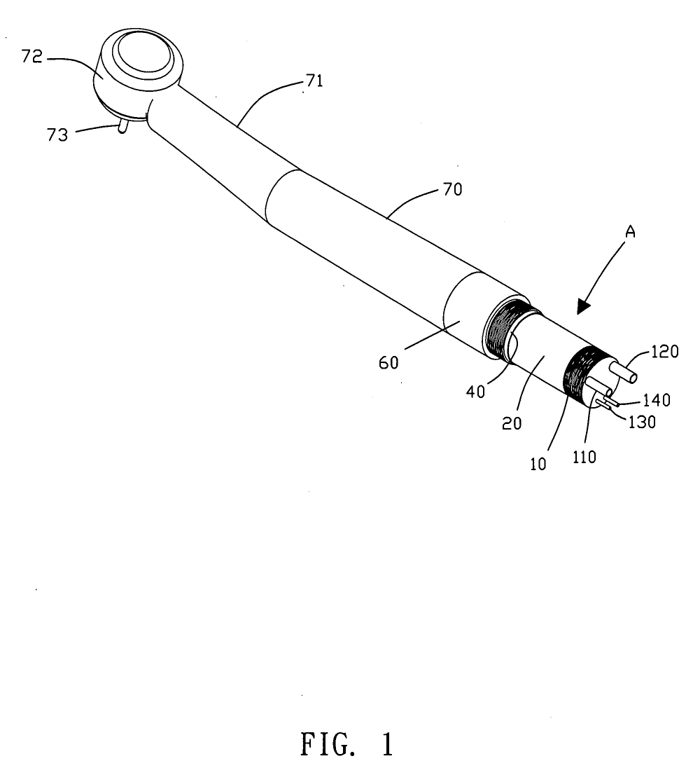

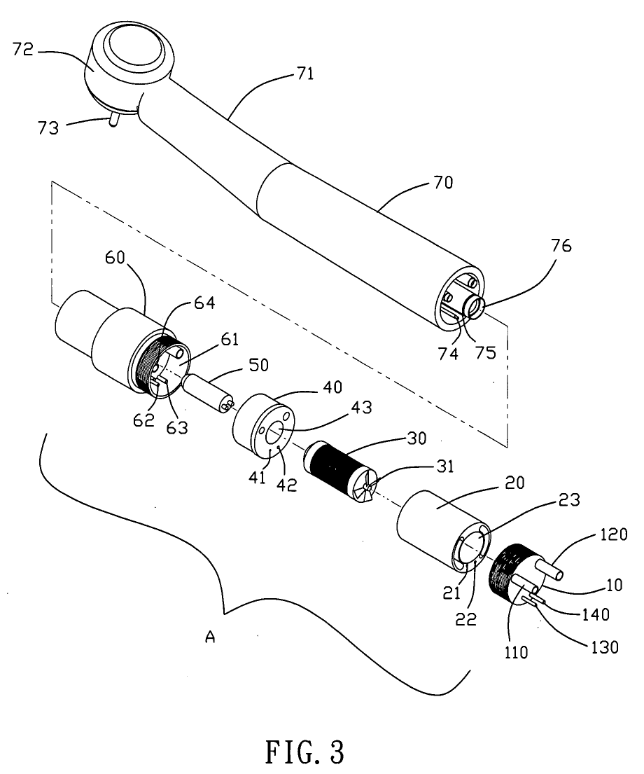

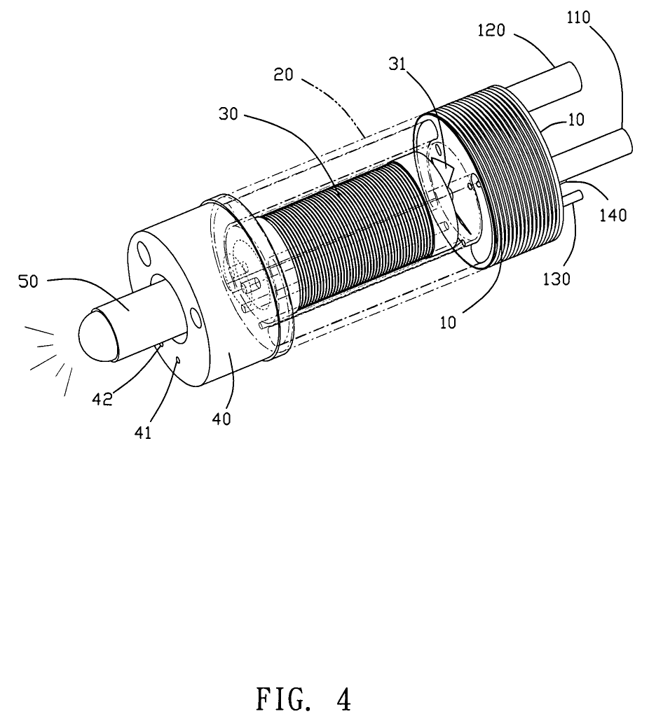

Referring to FIGS. 1-4, a dental medical tool in accordance with the present invention comprises a coupler A and a hollow grip 70 correspondingly connected with each other, wherein

the coupler A is comprised of a end holder 10, a fixing seat 20, a dynamo 30, a lamp mount 40, a light emitting element 50 and a connecting block 60.

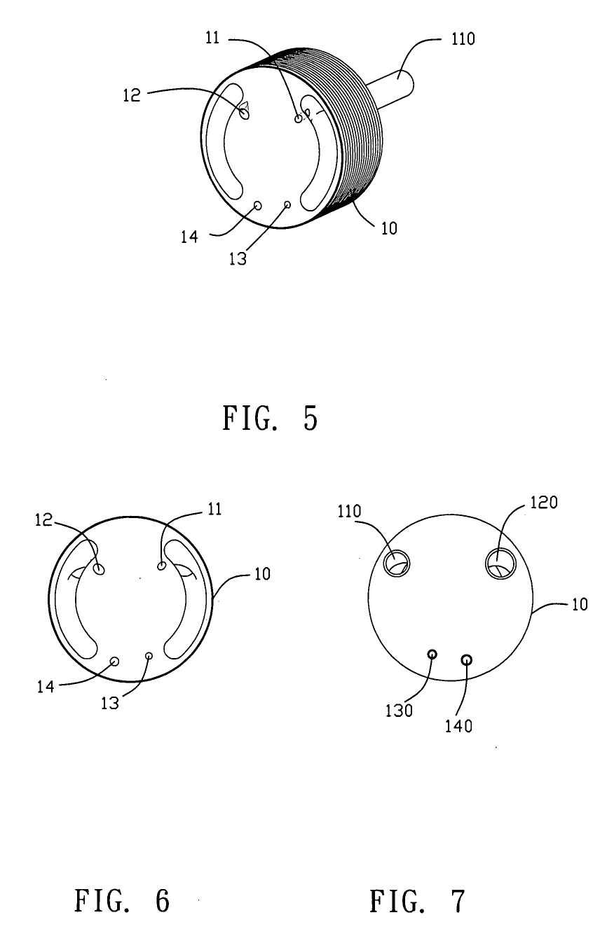

As shown in FIGS. 5-7, the end holder 10 includes an air inlet 11 and an air outlet 12 both slantly provided on the upper portion thereof and communicating therewith, and includes pegs 110, 120 extendedly disposed on the end portion thereof and corresponding to each other, and includes a water inlet 13 and a water outlet 14 mounted on the bottom thereof and communicating therewith, and further includes pillars 130, 140 extendedly arranged at the distal end thereof and corresponding to each other.

As shown in FIGS. 1-4, the distal end of the fixing seat 20 is correspondingly coupled with the front end of the end holder 10, and the fixing seat 20 involves a water admitting passage 21 and a water venting passage 22 formed thereon, for correspondingly connecting with the water inlet 13 and the water outlet 14 of the end holder 10, and contains a groove 23 provided at the center thereof, extendedly communicating with two ends thereof, the air inlet 11 and the air outlet 12, and having a dynamo 30 received therein.

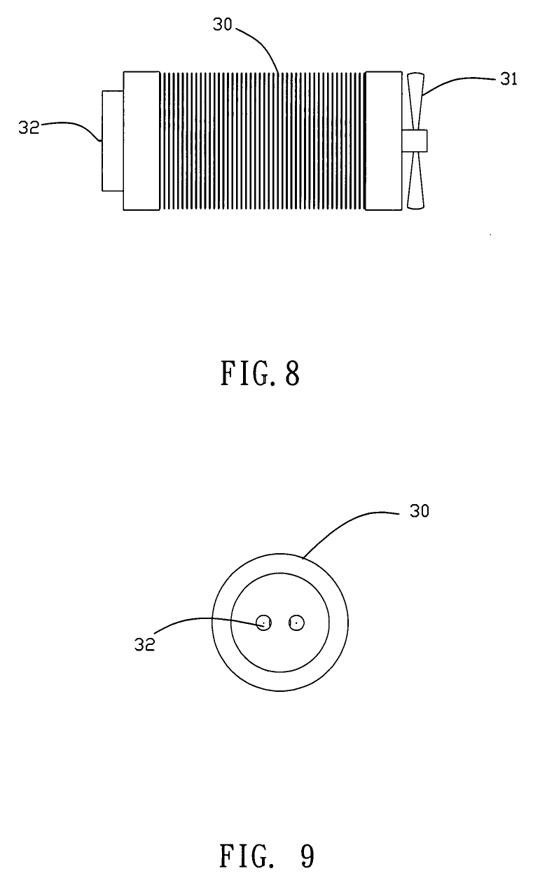

With reference to FIGS. 8 and 9, the dynamo 30 includes a fan 31 pivotally secured at the distal end thereof, a power connector 32 attached at the front end thereof, the fan 31 may utilize the air inlet 11 and the air outlet 12 to generate an inclined interaction during air flowing, such that the dynamo 30 is actuated to let the power connector 32 output voltage.

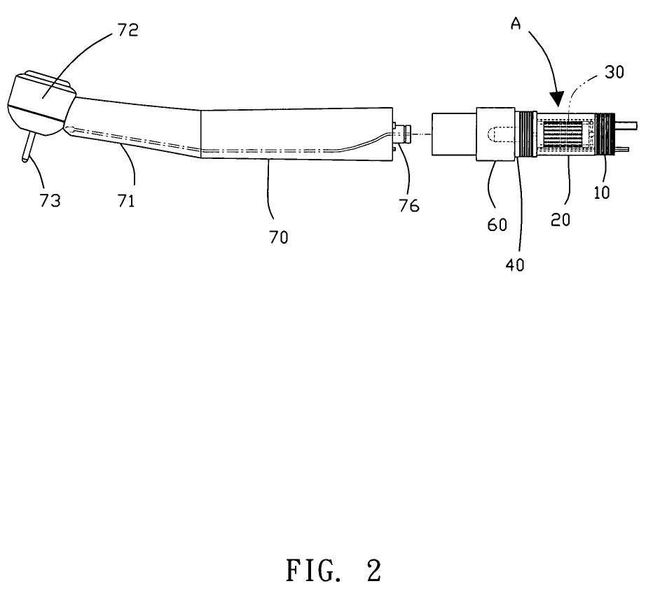

As illustrated in FIGS. 2-4, the distal end of a lamp mount 40 is correspondingly connected with the front end of the fixing seat 20, and the lamp mount 40 includes a water admitting duct 41 and a water venting duct 42 formed thereon and communicating therewith, for correspondingly connecting with the water admitting passage 21 and the water venting passage 22 of the fixing seat 20, and includes a groove 43 arranged at the center thereof and communicating with two ends thereof, for fixing a light emitting element 50 therein, such that the distal end of the light emitting element 50 couples with the power connector 32 of the dynamo 30.

Referring to FIGS. 1-3, a compartment 61 is defined at the distal end of a connecting block 60 for fitting the front end of the lamp mount 40 therein, and includes an inflow stem 62 and an outflow stem 63 affixed therein and communicating with two ends thereof, for correspondingly coupling with the water admitting duct 41 and the water venting duct 42 of the lamp mount 40. Besides, the connecting block 60 includes a through bore 64 disposed at the center thereof and communicating with two ends thereof, for fitting the front end of the light emitting element 50 therein.

The distal end of a grip 70 is connected with the front end of the connecting block 60, and the grip 70 includes a small-diameter and titled neck portion 71 extendedly mounted at the front end thereof and having a head segment 72 arranged at the front end thereof, the head segment 72 contains a dental treatment tool 73 pivotally attached thereon, and the grip 70 includes a water inflow tube 74 and a water outflow tube 75 couplingly fixed therein, severing to actuate the rotation of the treatment tool 73, and connecting with the inflow stem 62 and the outflow stem 63 of the connecting block 60, respectively. Furthermore, in the predetermined position of the grip 70 corresponding to the treatment tool 73 is provided with a window, and the grip 70 includes a light guiding element 76 arranged thereon and extendedly coupling with the window, wherein the light guiding element 76 may be a fiber tube or a quartz tube, and another end thereof joins with the front end of the light emitting element 50.

It can be clearly seen from the preceding accounts on the features of the present invention that the dental medical tool of the present invention has the following advantages:

1. The prior art dental medical tool has to change its all related structure, however, the present invention only has to additionally dispose the dynamo 30 therein and increase the length of the fixing seat 20 for achieving the best efficiency, thereby obtaining an economical purpose.

2. Because the dynamo 30 is built in the coupler 4, coupling with a power source outside is unnecessary, thereby saving power.

3. By using high pressure air to flow in or out of the coupler A, the dynamo 30 is actuated to operate, and due to the increased length of the fixing seat 20, the heat sinking area is enhanced, thus preventing an overheating problem.

The invention is not limited to the above embodiment but various modifications thereof may be made. It will be understood by those skilled in the art that various changes in form and detail may made without departing from the scope and spirit of the present invention.

What is claimed is:

1. A dental medical tool comprising:
a coupler and a hollow grip correspondingly connected with each other, wherein
said coupler contains a groove for receiving a dynamo therein, and includes an air inlet and an air outlet both communicating with said groove, and said dynamo couples with a light emitting element and includes a fan pivotally secured at the distal end thereof for utilizing said air inlet and said air outlet to generate an inclined interaction during air flowing, such that said dynamo is actuated to let a power connector output voltage for activating said light emitting element;
said grip includes a treatment tool pivotally disposed thereon, and in the predetermined position thereof corresponding to said treatment tool is provided with a window, said grip further includes a light guiding element arranged thereon and extendedly coupling with the window and said light emitting element.

2. The dental medical tool as claimed in claim 1, wherein said air inlet and said air outlet communicate with said compartment for generating an inclined interaction during air flowing, hence said dynamo is actuated to operate.

3. The dental medical tool as claimed in claim 1, wherein the distal end of said grip is connected with the front end of said coupler, and said grip includes a neck portion extendedly mounted at the front end thereof and having a head segment arranged at the front end thereof, said head segment contains a dental treatment tool pivotally attached thereon.

4. The dental medical tool as claimed in claim 2, wherein the distal end of said grip is connected with the front end of said coupler, and said grip includes a neck portion extendedly mounted at the front end thereof and having a head segment arranged at the front end thereof, said head segment contains a dental treatment tool pivotally attached thereon.

5. The dental medical tool as claimed in claim 1, wherein said coupler is comprised of a end holder, a fixing seat, said dynamo, a lamp mount, said light emitting element and a connecting block, wherein
said end holder includes an air inlet and an air outlet both slantly provided on the upper portion thereof and communicating therewith, and includes a water inlet and a water outlet mounted on the bottom thereof and communicating therewith;
the distal end of said fixing seat is correspondingly coupled with the front end of said end holder, and said fixing seat involves a water admitting passage and a water venting passage formed thereon, for correspondingly connecting with said water inlet and said water outlet of said end holder, and contains said groove provided at the center thereof and extendedly communicating with two ends thereof, said air inlet and said air outlet;
said dynamo includes a power connector attached at the front end thereof for coupling with the distal end of said light emitting element;
the distal end of said lamp mount is correspondingly connected with the front end of said fixing seat, and said lamp mount includes a water admitting duct and a water venting duct formed thereon and communicating therewith, for correspondingly connecting with said water admitting passage and said water venting passage of said fixing seat, and includes said groove arranged at the center thereof and communicating with two ends thereof, for fixing said light emitting element therein;
said compartment is defined at the distal end of said connecting block for fitting the front end of said lamp mount therein, and includes an inflow stem and an outflow stem affixed therein and communicating with two ends thereof, for correspondingly coupling with said water admitting duct and said water venting duct of said lamp mount, besides, said connecting block includes a through bore disposed at the center thereof and communicating with two ends thereof, for fitting the front end of said light emitting element therein;
said grip includes a water inflow tube and a water outflow tube couplingly fixed therein, severing to actuate the rotation of said treatment tool, and connecting with said inflow stem and said outflow stem of said connecting block, respectively.

6. The dental medical tool as claimed in claim 2, wherein said coupler is comprised of a end holder, a fixing seat, said dynamo, a lamp mount, said light emitting element and a connecting block, wherein
said end holder includes an air inlet and an air outlet both slantly provided on the upper portion thereof and communicating therewith, and includes a water inlet and a water outlet mounted on the bottom thereof and communicating therewith;
the distal end of said fixing seat is correspondingly coupled with the front end of said end holder, and said fixing seat involves a water admitting passage and a water venting passage formed thereon, for correspondingly connecting with said water inlet and said water outlet of said end holder, and contains said groove provided at the center thereof and extendedly communicating with two ends thereof, said air inlet and said air outlet;
said dynamo includes a power connector attached at the front end thereof for coupling with the distal end of said light emitting element;
the distal end of said lamp mount is correspondingly connected with the front end of said fixing seat, and said lamp mount includes a water admitting duct and a water venting duct formed thereon and communicating therewith, for correspondingly connecting with said water admitting passage and said water venting passage of said fixing seat, and includes said groove arranged at the center thereof and communicating with two ends thereof, for fixing said light emitting element therein;
said compartment is defined at the distal end of said connecting block for fitting the front end of said lamp mount therein, and includes an inflow stem and an outflow stem affixed therein and communicating with two ends thereof, for correspondingly coupling with said water admitting duct and said water venting duct of said lamp mount, besides, said connecting block includes a through bore disposed at the center thereof and communicating with two ends thereof, for fitting the front end of said light emitting element therein;
said grip includes a water inflow tube and a water outflow tube couplingly fixed therein, severing to actuate the rotation of said treatment tool, and connecting with said inflow stem and said outflow stem of said connecting block, respectively.

7. The dental medical tool as claimed in claim 3, wherein said coupler is comprised of a end holder, a fixing seat, said dynamo, a lamp mount, said light emitting element and a connecting block, wherein
said end holder includes an air inlet and an air outlet both slantly provided on the upper portion thereof and communicating therewith, and includes a water inlet and a water outlet mounted on the bottom thereof and communicating therewith;
the distal end of said fixing seat is correspondingly coupled with the front end of said end holder, and said fixing seat involves a water admitting passage and a water venting passage formed thereon, for correspondingly connecting with said water inlet and said water outlet of said end holder, and contains said groove provided at the center thereof and extendedly communicating with two ends thereof, said air inlet and said air outlet;
said dynamo includes a power connector attached at the front end thereof for coupling with the distal end of said light emitting element;
the distal end of said lamp mount is correspondingly connected with the front end of said fixing seat, and said lamp mount includes a water admitting duct and a water venting duct formed thereon and communicating therewith, for correspondingly connecting with said water admitting passage and said water venting passage of said fixing seat, and includes said groove arranged at the center thereof and communicating with two ends thereof, for fixing said light emitting element therein;
said compartment is defined at the distal end of said connecting block for fitting the front end of said lamp mount therein, and includes an inflow stem and an outflow stem affixed therein and communicating with two ends thereof, for correspondingly coupling with said water admitting duct and said water venting duct of said lamp mount, besides, said connecting block includes a through bore disposed at the center thereof and communicating with two ends thereof, for fitting the front end of said light emitting element therein;
said grip includes a water inflow tube and a water outflow tube couplingly fixed therein, severing to actuate the rotation of said treatment tool, and connecting with said inflow stem and said outflow stem of said connecting block, respectively.

8. The dental medical tool as claimed in claim 1, wherein said light guiding element may be a fiber tube.

9. The dental medical tool as claimed in claim 2, wherein said light guiding element may be a quartz tube.
